(19) United States
(12) Patent Application Publication
(10) Pub. No.: US 2021/0065353 A1
(43) Pub. Date: Mar. 4, 2021

(54) AUTOMATED COLLECTIBLE CARD GRADING SYSTEM

(71) Applicant: Nectar Exchange LLC, Wilmington, DE (US)

(72) Inventors: Jake Potter, Chappaqua, NY (US); Max A. Krakow, Chappaqua, NY (US); Evan Scott, Chappaqua, NY (US); Alec Y. Xiang, Mount Kisco, NY (US)

(21) Appl. No.: 17/003,182

(22) Filed: Aug. 26, 2020

Related U.S. Application Data
(60) Provisional application No. 62/894,385, filed on Aug. 30, 2019.

(51) Int. Cl. G06T 7/00; G06T 7/13; G06T 11/60; A63F 13/46

(52) U.S. Cl. CPC G06T 7/0002; G06T 7/13; G06T 11/60; G06T 2207/20084; G06T 2207/30168; G06T 2207/20081; A63F 13/46

(57) ABSTRACT

An automated collectible card grading system includes a memory, a communication interface and a processor configured to execute instructions that include receiving a target image of a collectible card depicting a subject, isolating spatial features of the target image, generating a card feature model, applying the card feature model to the isolated spatial features to create a plurality of card metrics, and creating a grade report for the collectible card based on the card metrics. The card feature model is generated using a deep learning algorithm trained using other images of other collectible cards that are also isolated into spatial features. Isolated special features can include corners, edge regions, central regions, and surface impressions. The graded collectible card subject is a specific collectible card representation created by a collectible card manufacturer and can be different than the subjects of the other collectible cards used by the card feature model.

### CROSS-REFERENCE TO RELATED APPLICATIONS

This application claims the benefit of U.S. Provisional Patent Application No. 62/894,385, filed Aug. 30, 2019, which are all hereby incorporated by reference in their entirety.

### TECHNICAL FIELD

The present disclosure relates generally to collectibles, and more particularly to the grading of collectible trading cards.

### BACKGROUND

Sports collectible cards and games that use collectible trading cards are popular hobbies. These can include, for example, baseball cards, football cards, Pokemon® cards, Magic the Gathering® cards, and other types of cards that are collectible and tradable. Card condition is important, especially for rare cards that have significant value. It is generally well known that collectible cards having defects or wear can be worth a lot less than cards of the same subject that are in pristine condition. For example, a “poor” card may have torn corners, worn edges, surface scratches, and a printing that is off-center. This can result in a trade or sale value for the poor card that is worth less than half of the value for another card of that same subject that is in “mint” condition. The professional grading of collectible cards is thus a significant industry having a market that is worth millions of dollars per year.

Currently collectible cards can be provided to grading companies where they are manually reviewed and assigned a grade by professionals who follow a grading system. This often requires a card owner to ship his or her card to a grading company, pay a fee, and wait up to a month or more to get the card returned with an assigned grade. Existing companies that provide manual collectible card grading services include Beckett, PSA, SGC, and others. These services rely on human judgment, and as such can be somewhat subjective and inconsistent. Other companies in the collectible card grading market use computer-based grading, but these service providers are generally thought to be simplistic, unreliable, and unpopular. Some of these involve the computerized scanning and grading of cards, but there is little transparency or confidence in the accuracy of these methodologies.

One example of a computerized grading system for collectible cards can be found in U.S. Pat. No. 10,146,841 to Kass et al. This system captures a full image of a collectible to be graded and compares the full image against a “Golden Image” (i.e., “perfect image”) of that collectible from a datastore of Golden Images. This system updates its Golden Image for a given subject whenever a better version than the currently stored Golden Image for that subject is found. This can result in unreliable and inconsistent gradings, particularly where different Golden Images are used over time for collectibles involving the same exact subject. Use of this system depends on the availability and accuracy of having truly perfect reference images for all the different types and subjects of collectible cards, which may prove difficult and unreliable in practice. Furthermore, this system compares full images to full images, and does not appear to provide consistency across different collectible subjects due to variances in the inherently imperfect natures of its different Golden Images.

Accordingly, there is a need for improved collectible card grading services and systems. Although traditional collectible card grading services have worked well in the past, improvements for this industry are desired. In particular, what is desired are automated collectible card grading systems that provide speed, reliability, and consistency in a manner that satisfy consumer confidence.

### SUMMARY

It is an advantage of the present disclosure to provide collectible card grading apparatuses, systems, and methods that are faster, more reliable, and more consistent than existing providers of card grading services. The disclosed automated apparatuses, systems, and methods provide a fast and objective alternative to human-based grading, which is prone to the variations of individual graders. The disclosed automated systems and methods are also scalable and can be deployed on multiple systems and computers to meet demand. These advantages can be accomplished at least in part by utilizing a card feature model that involves a deep learning algorithm trained using images of collectible cards, and in particular images of isolated portions of collectible cards.

In various embodiments of the present disclosure, a method of grading a collectible card can include the process steps of receiving a target image of the collectible card, isolating spatial features of the target image, generating a card feature model, applying the card feature model, and creating a grade report for the collectible card. The collectible card can depict a subject that is a specific collectible card representation created by a collectible card manufacturer, and the target image of the card can be received from an image acquisition device. The isolated spatial features can include one or more of a corner, an edge region, a central region, and a surface impression of the collectible card. The card feature model can be generated using a deep learning algorithm that has been trained using other images of other collectible cards, and these other images can also have been isolated into spatial features including corners, edge regions, central regions, and surface impressions. The card feature model can be applied to one or more of the isolated spatial features of the target image to create a plurality of card metrics. The grade report for the collectible card can be based at least in part on one or more of the plurality of card metrics.

In various detailed embodiments, isolating a corner of the collectible card can include detecting a card corner in the target image and generating a bounding box around the card corner. Similarly, isolating an edge region of the collectible card can include detecting a card edge in the target image and generating a bounding box around a portion of the card edge that is less than the entire card edge. Isolating a central region of the collectible card can include detecting a central portion of the card that excludes all corners and all edge regions in the target image and generating a bounding box around the central region. Isolating a surface impression of the collectible card can include detecting one or more scratches, bumps, folds, or other surface imperfections of the card in the target image, and generating a bounding box around the one or more scratches, bumps, folds, or other surface imperfections. Further, isolating the spatial features can include zooming in on a spatial feature, generating a bounding box around the spatial feature, and clipping away the rest of the target image outside the spatial feature. Isolating the spatial features can also include translating the target image by moving the target image up, down, left, or right. In some embodiments, isolating the spatial features can include isolating every corner, every edge region, and every central region of the collectible card.

In further detailed embodiments, generating the card feature model can include inputting card metadata into the deep learning algorithm by entering data relating to the subject of the collectible card. Such data can include information regarding the year of issue, series, sport, game, title, or manufacturer of the collectible card. In various embodiments, the deep learning algorithm can include a convolutional neural network (“CNN”), and generating the card feature model can include compressing the CNN by pruning items having zero parameters and weights within the CNN. In addition, creating the grade report can include generating a score incorporating weighting or factor reduction for one or more of the plurality of card metrics.

In still further detailed embodiments, applying the card feature model can include comparing isolated spatial features of the collectible card being graded with isolated spatial features of the other collectible cards. Also, the other collectible cards used to train the deep learning algorithm can depict subjects that are different than the subject of the collectible card being graded. In various embodiments, the image acquisition device can be a smart phone, which can be a smart phone used by a consumer of the disclosed system. Also, the collectible card being graded can be a sports or trading game card.

In various other embodiments of the present disclosure, a system adapted for the automated grading of collectible cards can include at least one memory that contains non-transitory processor-executable instructions, a communication interface configured to facilitate communications between the system and separate computing devices outside the system, and a processor coupled to the at least one memory and to the communication interface. The processor can be configured to execute the processor-executable instructions, which can include instructions for receiving a target image of the collectible card, isolating spatial features of the target image, generating a card feature model, applying the card feature model, and creating a grade report for the collectible card. Various details regarding these instructions can include all or any subset of the details regarding the detailed method embodiments above.

In various additional embodiments of the present disclosure, an apparatus can include a processor configured to execute processor-executable instructions. These can include instructions for receiving a target image of a collectible depicting a subject, isolating spatial features of the target image, generating a feature model, applying the feature model, and creating a grade report for the collectible. Similar to the foregoing embodiments, the subject can be a specific representation created by a collectible manufacturer, and the spatial features can include one or more of an edge region, a central region, and a surface impression of the collectible. The feature model can be generated using a deep learning algorithm trained using other images of other collectibles, where the other images are isolated into spatial features including edge regions, central regions, and surface impressions. The feature model can be applied to one or more of the isolated spatial features of the target image to create a plurality of collectible metrics, and the grade report for the collectible can be based at least in part on one or more of plurality of collectible metrics. In various embodiments, generating the feature model can include inputting collectible metadata into the deep learning algorithm by entering data relating to the subject of the collectible. This data can include information regarding the year of issue, series, title, or manufacturer of the collectible. Further details regarding these additional embodiments can include all or any subset of the details regarding the detailed method and system embodiments above.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for the automated grading of collectible cards. These drawings in no way limit any changes in form and detail that may be made to the disclosure by one skilled in the art without departing from the spirit and scope of the disclosure.

FIG. 1A illustrates in front perspective view an exemplary computing device according to one embodiment of the present disclosure.

FIG. 1B illustrates in front perspective view an alternative exemplary computing device according to one embodiment of the present disclosure.

FIG. 1C illustrates in block diagram format an exemplary computerized data network according to one embodiment of the present disclosure.

FIG. 2 illustrates a diagram of an exemplary client or end user computing device or system according to one embodiment of the present disclosure.

FIG. 3 illustrates in block diagram format an exemplary client system for a mobile device according to one embodiment of the present disclosure.

FIG. 4 illustrates in block diagram format an exemplary server system according to one embodiment of the present disclosure.

FIG. 5 illustrates a flowchart of an exemplary overview method of grading a collectible card according to one embodiment of the present disclosure.

FIG. 6 illustrates a flowchart of an exemplary method of generating a card feature model using a deep learning algorithm according to one embodiment of the present disclosure.

FIG. 7 illustrates a flowchart of an exemplary method of isolating a card spatial feature according to one embodiment of the present disclosure.

FIG. 8 illustrates a flowchart of an exemplary method of creating a grade for a collectible card according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to apparatuses, systems, and methods for the automated grading of collectible trading cards. The disclosed systems and methods are faster, more reliable, and more consistent than existing providers of card grading services, particularly those that involve human-based grading, which is prone to the variations of individual human graders. The disclosed automated systems and methods are scalable, can be deployed on multiple systems and computers to meet demand, and can be accomplished at least in part by utilizing a card feature model that involves a deep learning algorithm trained using images of collectible cards that are stored in a database. Although the various embodiments disclosed herein focus on collectible trading cards for purposes of illustration, it will be readily appreciated that the disclosed apparatuses, systems, and methods can similarly be used for types of collectibles other than collectible trading cards.

In various detailed examples, which are merely illustrative and non-limiting in nature, an automated collectible card grading system includes a memory, a communication interface, and a processor configured to execute instructions for use on a special purpose computer. Such computer-executable instructions can include receiving a target image of a collectible card depicting a subject, isolating spatial features of the target image, generating a card feature model, applying the card feature model to the isolated spatial features to create a plurality of card metrics, and creating a grade report for the collectible card based on the card metrics. The card feature model can be generated using a deep learning algorithm trained using other images of other collectible cards that are also isolated into spatial features. Isolated spatial features can include corners, edge regions, central regions, and surface impressions, among other possible features. A collectible card being graded by the system can depict a subject that is a specific collectible card representation created by a collectible card manufacturer, and this subject can be different than the subjects of other collectible cards used by the card feature model during the automated collectible card grading process. The disclosed system is thus able to provide an accurate grade for any submitted collectible card regardless of whether any copies of that collectible card already exist in the system database.

In various embodiments, a consumer of the disclosed system can utilize the system simply by taking a picture of the collectible card to be graded using his or her own computing device, such as a personal smart phone. System software, of which all or a portion may be made locally available on the user device, can then use the acquired image to analyze the collectible card and provide a grade report for that collectible card. This can allow users to grade their own collectible cards accurately and safely from the comfort of their own homes and other convenient locations. The automated process can also provide professional quality grading for collectible cards in a matter of seconds, rather than the typical days or weeks that are currently required in the collectible card grading industry. Other advantages will also become readily apparent upon review of the figures and detailed description set forth below.

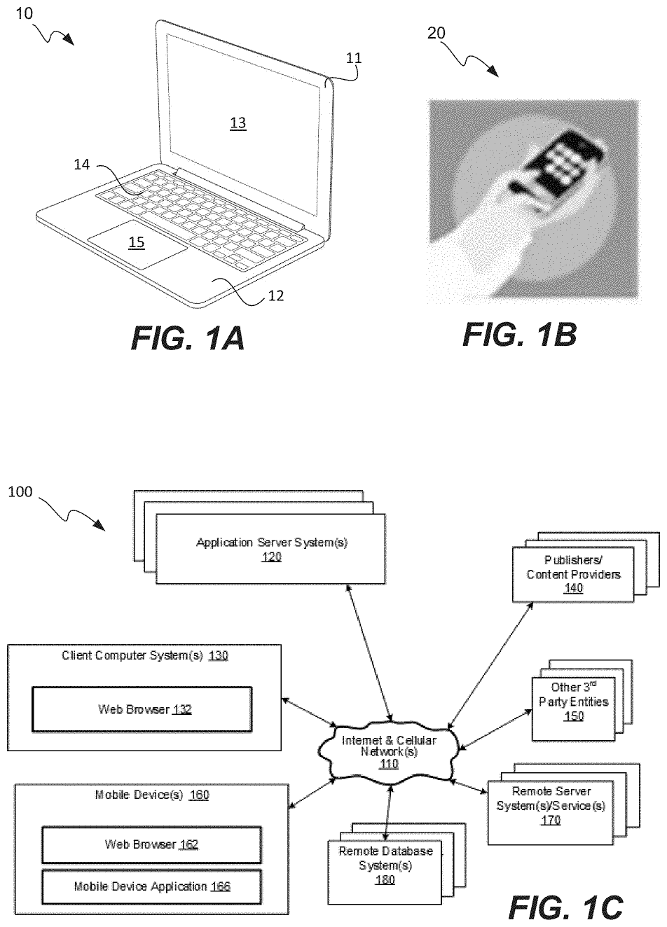

Referring first to FIG. 1A, an exemplary computing device according to one embodiment of the present disclosure is illustrated in front perspective view. Computing device 10, which can be a laptop computer, can be particularly adapted to provide various processing functions and services to a user, which can include automated collectible card grading services. It will be readily appreciated that computing device 10 can be provided in numerous other configurations and formats while still being able to provide the disclosed collectible grading services, such that the provided laptop example is for illustrative purposes only. For example, computing device 10 could also be a desktop computer, a tablet computer, a smart phone, a personal digital assistant, or the like.

In general, computing device 10 can include an upper portion 11 and a lower portion 12. Upper portion 11 can include a display component 13 having a display region thereupon, while lower portion 12 can include various input devices, such as a keyboard 14 and touchpad 15. Lower portion 12 may also include a processor (not shown) therein, which can be adapted to generate or process data for grading a collectible, provide display output regarding the grading of the collectible, and accept user input regarding grading the collectible. Such a processor can be coupled to the display component 13 and the input devices 14, 15, as well as other components of the computing device 10. Such other computing device components or items not shown may also be included, as will be readily appreciated, with such items including, for example, cameras, speakers, memories, busses, input ports, disk drives, power supplies, wireless interfaces, and the like.

FIG. 1B illustrates in front perspective view an alternative exemplary computing device according to one embodiment of the present disclosure. Smart phone 20 can similarly be used to provide various processing functions and services to a user, which can include automated collectible card grading services. As in the foregoing computing device 10, smart phone 20 can include at least a processor, display component having a display region, and one or more input devices, such as a touchscreen, camera, button(s) and/or a keypad. In various embodiments, an automated collectible card grading program or the like can be provided as a localized application or “app” on an app store that can be accessed from smart phone 20. Such an app can be downloaded and then played or used on the smart phone 20. Such an app can be a universal app configured to provide automated grading services for many types of collectibles, or can be specifically designed to provide automated grading for collectible cards only, such as those services that may be available from the provider of an “Automated Card Grading System.”

FIG. 1C illustrates in block diagram format an exemplary computerized data network according to one embodiment of the present disclosure. Computerized data network 100 can be used to implement an “Automated Card Grading System” adapted for the automated grading of collectible trading cards, for example. As described in greater detail herein, different embodiments of an Automated Card Grading System may be configured, designed, and/or operable to provide various different types of operations, functionalities, and/or features generally relating to the grading and/or commercialization of collectible trading cards. Further, as described in greater detail herein, many of the various operations, functionalities, and/or features of the disclosed Automated Card Grading System may enable or provide different types of advantages and/or benefits to different entities interacting with the disclosed system.

It is specifically contemplated that various embodiments of the present disclosure may be provided over a traditional distributed server and client-based network. Such a system or network can involve the use of individual computing devices as clients that all communicate with a central server or servers over a network, such as the Internet, during the automated grading process. Various embodiments may also include servers and systems adapted to provide the disclosed automated systems and variations thereof over a network, such as the Internet, in a manner such that the automated collectible card grading services can be fully performed locally on home computers, smart phones, and other personal computing devices, such as by using an app that is available on an app store or the like.

According to different embodiments, the Automated Card Grading System may include a plurality of different types of components, devices, modules, processes, systems and the like, which, for example, may be implemented and/or instantiated via the use of hardware and/or combinations of hardware and software. According to various embodiments, the computerized data network 100 adapted for implementation of an Automated Card Grading System may include a plurality of different types of components, devices, modules, processes, systems, etc., which, for example, may be implemented and/or instantiated via the use of hardware and/or combinations of hardware and software. For example, as illustrated in the example embodiment of FIG. 1C, network 100 may include one or more of the following types of systems, components, devices, processes, etc. (or combinations thereof):
Application Server System(s) 120—In at least one embodiment, the Application Server System(s) may be operable to perform and/or implement various types of functions, operations, actions, and/or other features such as those described or referenced herein.
Publisher/Content Provider System component(s) 140
Client Computer System (s) 130
3^{rd} Party System(s) 150
Internet & Cellular Network(s) 110
Remote Database System(s) 180
Remote Server System(s)/Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
Mobile Device(s) 160—In at least one embodiment, the Mobile Device(s) may be operable to perform and/or implement various types of functions, operations, actions, and/or other features such as those described or referenced herein.

In some embodiments, a decentralized server system may be used for an Automated Card Grading System. Rather than utilizing a centralized server, various system functions can be performed at multiple servers distributed at different locations across a distributed network. As such, while Application Server System(s) 120 can all be on one machine or placed at a single location, Application Server System(s) 120 may also be on multiple machines at multiple locations. For example, one portion of Application Server System(s) 120 relating to the acquisition of collectible card images may be located on a first server at one location, while another portion of Application Server System(s) 120 relating to the automated grading of collectible cards according to the acquired images may be located on a second server located at other location. Still another portion of Application Server System(s) 120 relating to the provision of collectible card grade reports may be located on a third server at still another location, while yet another portion of Application Server System(s) 120 relating to the commercialization of collectible cards based on the provided grade reports may be located on a fourth server at yet another location. Again, while a single server may provide all of these functions, it is also contemplated that multiple servers may be used to provide these different services, with some services provided by one server and others combined for performance on another server. Communications between the different portions of Application Server System(s) 120 may be arranged as appropriate to facilitate functionality between the different system portions.

In at least one embodiment, an Automated Card Grading System may be operable to utilize and/or generate various different types of data and/or other types of information when performing specific tasks and/or operations. This may include, for example, input data/information and/or output data/information. For example, in at least one embodiment, an Automated Card Grading System may be operable to access, process, and/or otherwise utilize information from one or more different types of sources, such as, for example, one or more local and/or remote memories, devices and/or systems. Additionally, in at least one embodiment, an Automated Card Grading System may be operable to generate one or more different types of output data/information, which, for example, may be stored in memory of one or more local and/or remote devices and/or systems. Examples of different types of input data/information and/or output data/information which may be accessed and/or utilized by an Automated Card Grading System may include, but are not limited to, one or more of those described and/or referenced herein. According to specific embodiments, multiple instances or threads of an Automated Card Grading System may be concurrently implemented and/or initiated via the use of one or more processors and/or other combinations of hardware and/or hardware and software. For example, in at least some embodiments, various aspects, features, and/or functionalities of an Automated Card Grading System may be performed, implemented and/or initiated by one or more of the various systems, components, systems, devices, procedures, processes, etc., described and/or referenced herein.

In at least one embodiment, a given instance of an Automated Card Grading System may access and/or utilize information from one or more associated databases. In at least one embodiment, at least a portion of the database information may be accessed via communication with one or more local and/or remote memory devices. Examples of different types of data which may be accessed by an Automated Card Grading System may include, but are not limited to, one or more of those described and/or referenced herein. According to different embodiments, various different types of encryption/decryption techniques may be used to facilitate secure communications between devices in an Automated Card Grading System and/or other networks. Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Automated Card Grading System of FIG. 1C is but one example from a wide range of Automated Card Grading System embodiments which may be implemented. Other embodiments of an Automated Card Grading System (not shown) may include additional, fewer and/or different components/features that those illustrated in FIG. 1C. Generally, the various techniques for implementing an Automated Card Grading System or other similar system described herein may be implemented in software, hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Software, hardware and/or software+hardware hybrid embodiments of the Automated Card Grading System techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, and the like.

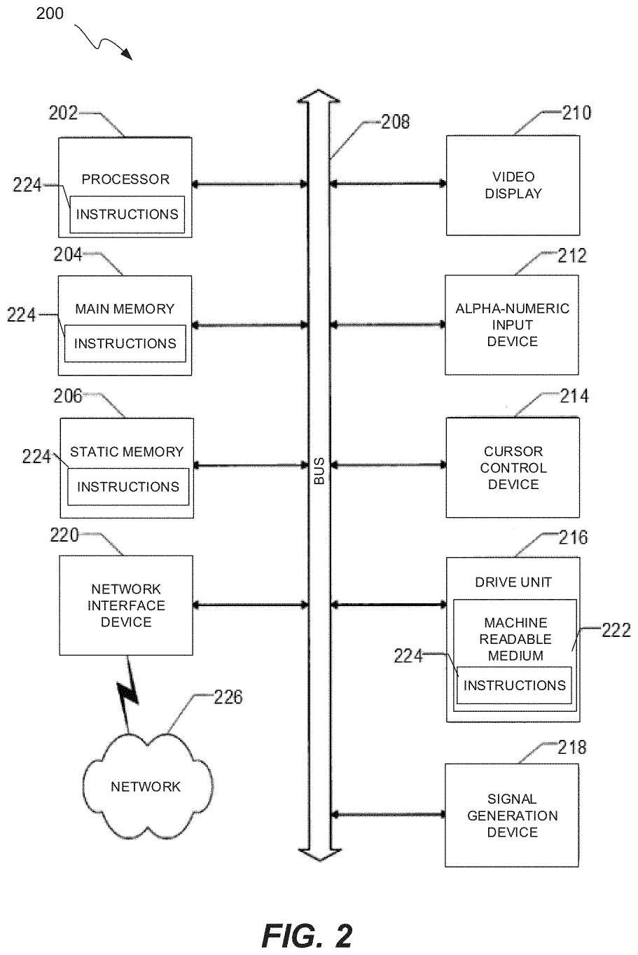

Turning next to FIG. 2, a diagrammatic representation of an exemplary client or end user computing device or system is provided. Computing device or system 200 can be identical or similar to any of the foregoing computer devices 10, 20, as well as any other suitable computing device or system adapted for providing the disclosed Automated Card Grading System. Computing device or system 200 may contain a set of instructions for causing itself or another networked machine to perform any one or more of the methodologies discussed herein. As such, computing device or system 200 may operate as a standalone device or machine, or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Exemplary computer device or system 200 includes a processor 202 (e.g., a central processing unit (CPU), a graphics processing unit (GPU) or both), a main memory 204 and a static memory 206, which communicate with each other via a bus 208. The computer device or system 200 may further include a video display unit 210 (e.g., a liquid crystal display (LCD) or a cathode ray tube (CRT)), and also an alphanumeric input device 212 (e.g., a keyboard), a user interface (UI) navigation device 214 (e.g., a mouse), a disk drive unit 216, a signal generation device 218 (e.g., a speaker) and a network interface device 220. The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer device or system 200, wherein the main memory 204 and/or the processor 202 may also be constituting machine-readable media.

The software 224 may further be transmitted or received over a network 226 via the network interface device 220 utilizing any one of a number of well-known transfer protocols (e.g., HTTP). While the machine-readable medium 222 is shown in an exemplary embodiment to be a single medium, the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

According to various embodiments, computing device or system 200 may include a variety of components, modules and/or systems for providing various types of functionality. For example, in at least one embodiment, device or system 200 may include a web browser application which is operable to process, execute, and/or support the use of scripts (e.g., JavaScript, AJAX, etc.), Plug-ins, executable code, virtual machines, HTMLS vector-based web animation (e.g., Adobe Flash), etc. In at least one embodiment, the web browser application may be configured or designed to instantiate components and/or objects at the device or system 200 in response to processing scripts, instructions, and/or other information received from a remote server such as a web server. Examples of such components and/or objects may include, but are not limited to, UI components, database components, processing components, and other components that may facilitate and/or enable device or system 200 to perform and/or initiate various types of operations, activities, functions such as those described herein with respect to providing an Automated Card Grading System or other similar automated collectible grading system.

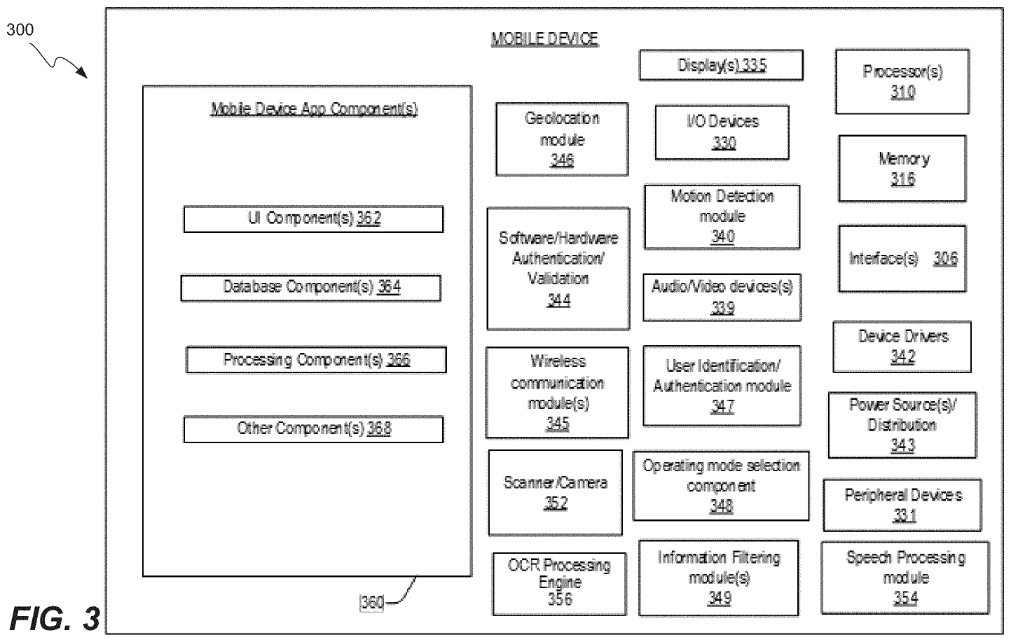

Continuing with FIG. 3, a block diagram of an exemplary client system for a mobile device is provided. In at least one embodiment, the mobile device client system 300 may include an Automated Card Grading System Component, which has been configured or designed to provide functionality for enabling or implementing at least a portion of the various Automated Card Grading System software modules or components at the mobile device client system. Such a mobile device app component can be provided for download by a service provider, such as an app store for smart phone devices. Various aspects, features, and/or functionalities of client system 300 may be performed, implemented and/or initiated by one or more of the following types of systems, components, systems, devices, procedures, processes, and the like. Such items can include, for example: Processor(s) 310, Device Drivers 342, Memory 316, Interface(s) 306, Power Source(s)/Distribution 343, Geolocation module 346, Display(s) 335, I/O Devices 330, Audio/Video devices(s) 339, Peripheral Devices 331, Motion Detection module 340, User Identification/Authentication module 347, Software/Hardware Authentication/Validation 344, Wireless communication module(s) 345, Information Filtering module(s) 349, Operating mode selection component 348, Speech Processing module 354, Scanner/Camera 352, and OCR Processing Engine 356, among other possible components.

As illustrated in the example of FIG. 3, mobile device 300 may include a variety of components, modules and/or systems for providing various functionalities. For example, Mobile Device 300 may include Mobile Device Application components (e.g., 360), which, for example, may include, but are not limited to, one or more of the following (or combinations thereof): UI Components 362, Database Components 364, Processing Components 366, and Other Components 368 which, for example, may include components for facilitating and/or enabling the mobile device to perform and/or initiate various types of operations, activities, functions such as those described herein. In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 300 may further include, but is not limited to, different types of components, modules and/or systems (or combinations thereof) such as, for example, one or more of the following.
At least one processor 310. In at least one embodiment, the processor(s) 310 may include one or more commonly known CPUs that are deployed in many current consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile random access memory (“RAM”) and/or read only memory (“ROM”)) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 316, which, for example, may include volatile memory (e.g., RAM), non-volatile memory (e.g., disk memory, FLASH memory, EPROMs, etc.), unalterable memory, and/or other types of memory. In at least one implementation, the memory 316 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various Automated Card Grading System components described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the Automated Card Grading System components described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM devices. Examples of program instructions include both machine code, such as produced by a compiler, and files containing higher level code that may be executed by the computer using an interpreter.
Interface(s) 306 which, for example, may include wired interfaces and/or wireless interfaces. In at least one implementation, the interface(s) 306 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, and the like.
Device driver(s) 342. In at least one implementation, the device driver(s) 342 may include functionality similar to at least a portion of functionality implemented by one or more computer system driver devices such as those described herein and/or generally known to one having ordinary skill in the art.
At least one power source (and/or power distribution source) 343. In at least one implementation, the power source may include at least one mobile power source (e.g., battery) for allowing the client system to operate in a wireless and/or mobile environment. For example, in one implementation, the power source 343 may be implemented using a rechargeable, thin-film type battery. Further, in embodiments where it is desirable for the device to be flexible, the power source 343 may be designed to be flexible.
Geolocation module 346 which, for example, may be configured or designed to acquire geolocation information from remote sources and use the acquired geolocation information to determine information relating to a relative and/or absolute position of the client system.
Motion detection component 340 for detecting motion or movement of the client system and/or for detecting motion, movement, gestures and/or other input data from user. In at least one embodiment, the motion detection component 340 may include one or more motion detection sensors such as, for example, MEMS (Micro Electro Mechanical System) accelerometers, that can detect the acceleration and/or other movements of the client system as it is moved by a user.
One or more display(s) 335. According to various embodiments, such display(s) may be implemented using, for example, LCD display technology, OLED display technology, and/or other types of conventional display technology. In at least one implementation, display(s) 335 may be adapted to be flexible or bendable. Additionally, in at least one embodiment the information displayed on display(s) 335 may utilize e-ink technology (such as that available from E Ink Corporation, Cambridge, Mass., www.eink.com), or other suitable technology for reducing the power consumption of information displayed on the display(s) 335.
User Identification/Authentication module 347. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user that provides a wireless signal to the client system for determining the identity of the current user. In at least one implementation, various security features may be incorporated into the client system to prevent unauthorized users from accessing confidential or sensitive information.
One or more user I/O Device(s) 330 such as, for example, keys, buttons, scroll wheels, cursors, touchscreen sensors, audio command interfaces, magnetic strip reader, optical scanner, etc.
Audio/Video device(s) 339 such as, for example, components for displaying audio/visual media which, for example, may include cameras, speakers, microphones, media presentation components, wireless transmitter/receiver devices for enabling wireless audio and/or visual communication between the client system 300 and remote devices (e.g., radios, telephones, computer systems, etc.). For example, in one implementation, the audio system may include componentry for enabling the client system to function as a cell phone or two-way radio device.
Other types of peripheral devices 331 which may be useful to the users of various client systems, such as, for example: PDA functionality; memory card reader(s); fingerprint reader(s); image projection device(s); social networking peripheral component(s); etc.
Information filtering module(s) 349 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 349 may also be adapted to display, in real-time, filtered information to the user based upon a variety of criteria such as, for example, geolocation information, contextual activity information, and/or other types of filtering criteria described and/or referenced herein.
Wireless communication module(s) 345. In one implementation, the wireless communication module 345 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 344 which, for example, may be used for authenticating and/or validating local hardware and/or software components, hardware/software components residing at a remote device, user information and/or identity, etc.
Operating mode selection component 348 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 352) which may be configured or designed for use in scanning identifiers and/or other content from other devices and/or objects such as for example: mobile device displays, computer displays, static displays (e.g., printed on tangible mediums), or any other means of scanning taking a picture, or otherwise forming an image of a collectible to be graded by the system.
OCR Processing Engine (e.g., 356) which, for example, may be operable to perform image processing and optical character recognition of images such as those captured by a mobile device camera, for example.
Speech Processing module (e.g., 354) which, for example, may be operable to perform speech recognition, and may be operable to perform speech-to-text conversion.

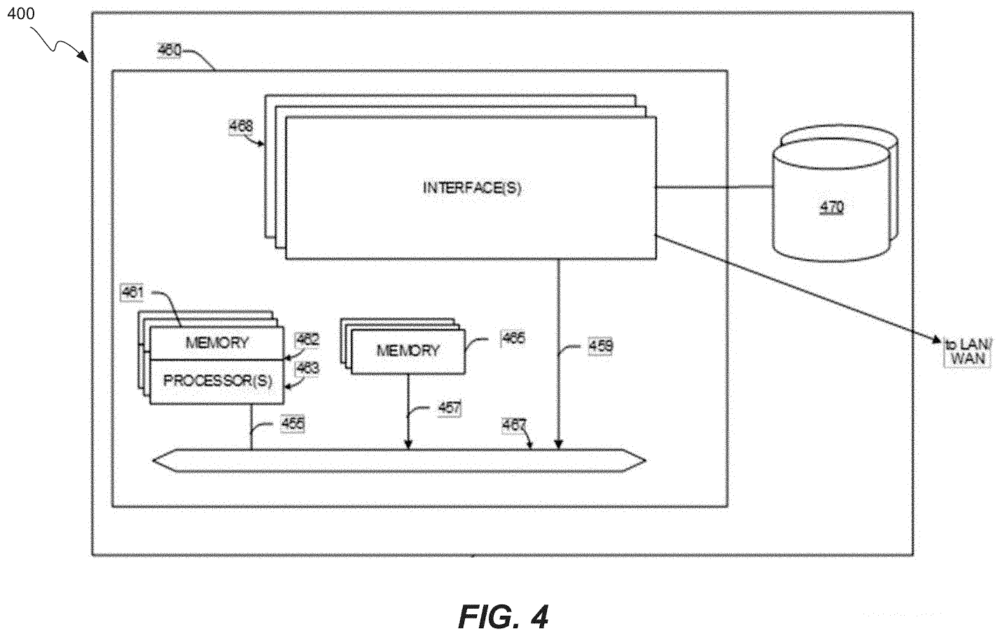

FIG. 4 illustrates in block diagram format an exemplary server system 400, which may be used for implementing various aspects/features described herein. In at least one embodiment, the server system 400 includes at least one network device 460, and at least one storage device 470 (such as, for example, a direct attached storage device). In one embodiment, server system 400 may be suitable for implementing at least some of the Automated Card Grading System techniques described herein.

According to one embodiment, network device 460 may include a master central processing unit (CPU) 462, interfaces 468, and a bus 467 (e.g., a PCI bus). When acting under the control of appropriate software or firmware, the CPU 462 may be responsible for implementing specific functions associated with the functions of a desired network device. For example, when configured as a server, the CPU 462 may be responsible for analyzing packets; encapsulating packets; forwarding packets to appropriate network devices; instantiating various types of virtual machines, virtual interfaces, virtual storage volumes, virtual appliances; etc. The CPU 462 preferably accomplishes at least a portion of these functions under the control of software including an operating system (e.g. Linux), and any appropriate system software (such as, for example, AppLogic™ software).

CPU 462 may include one or more processors 463 such as, for example, one or more processors from the AMD, Motorola, Intel and/or MIPS families of microprocessors. In an alternative embodiment, processor 463 may be specially designed hardware for controlling the operations of server system 400. In a specific embodiment, a memory 461 (such as non-volatile RAM and/or ROM) also forms part of CPU 462. However, there may be many different ways in which memory could be coupled to the system. Memory block 461 may be used for a variety of purposes such as, for example, caching and/or storing data, programming instructions, and the like.

The interfaces 468 may be typically provided as interface cards (sometimes referred to as “line cards”). Alternatively, one or more of the interfaces 468 may be provided as on-board interface controllers built into the system motherboard. Generally, they control the sending and receiving of data packets over the network and sometimes support other peripherals used with the server system 400. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communication intensive tasks, these interfaces allow the master microprocessor 462 to efficiently perform routing computations, network diagnostics, security functions, and the like.

In at least one embodiment, some interfaces may be configured or designed to allow the server system 400 to communicate with other network devices associated with various local area networks and/or wide area networks. Other interfaces may be configured or designed to allow network device 460 to communicate with one or more direct attached storage device(s) 470. Although the system shown in FIG. 4 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device configuration, a network may employ one or more memories or memory modules (such as, for example, memory block 465, which, for example, may include RAM) configured to store data, program instructions for the general-purpose network operations and/or other information relating to the functionality of the various Automated Card Grading System techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as ROM and RAM. Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

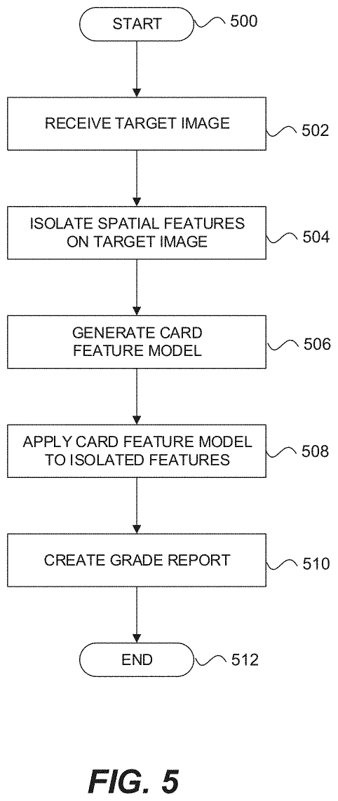

Turning next to FIG. 5, a flowchart of an exemplary method of grading a collectible card according to one embodiment of the present disclosure is provided. The method presented is a general overview of the automated grading process for a collectible card, such as by an Automated Card Grading System, and it will be understood that details may be omitted in this example for purposes of illustration. After a start step 500, a target image can be received at process step 502. The target image can be an image of the front face of a full collectible card having a specific subject, as provided by an image acquisition device. In various embodiments, the image acquisition device can be a camera controlled by a consumer or other user of an Automated Card Grading System, such as a camera on a smart phone or other computing device owned or operated by the user of the system.

At a subsequent process step 504, spatial features on the target image can be isolated. This isolation of target features can involve the use of an object detection system, such as R-CNN, SSD, or YOLO, for example. In various embodiments, it is specifically contemplated that YOLOv3 is used to detect and isolate spatial features on the target image of the collectible card. In the disclosed systems, a YOLOv3 algorithm can be trained manually to predict user-defined bounding boxes in target images and can then be deployed on newly captured images to detect entire cards and isolated features in the captured images, and then provide them with bounding boxes. In some embodiments, one or more pre-processing steps may be performed prior to isolating spatial features on the target image, as detailed below.

At process step 506, a card feature model can be generated. The card feature model can be generated using a deep learning algorithm, such as a convolutional neural network (“CNN”). A CNN used by the Automated Card Grading System disclosed herein can be trained using a database of boxed and pre-processed collectible card images. This database of card images can include full card images, as well as images of various spatial features on cards that have been isolated. For example, the database can include numerous images of card corners, edge regions, central regions, surface impressions, and other card features that have been isolated using the YOLOv3 or another similar object detection algorithm. These images of isolated card portions, many of which are substantially less than images of full cards, can come from different collectible cards that are manually provided to Automated Card Grading System for training purposes, as well as from collectible cards that have been previously graded by the system.

At a following process step 508, the card feature model can be applied to the card spatial features that were isolated in step 504. This application of the card feature model can involve comparing the isolated card spatial features of the card being graded against the isolated card spatial features contained in the system database. In preferred embodiments, the database can have many isolated spatial features of different types and qualities, each of which has already been graded or given a particular “score” based on the quality of that isolated spatial feature. For example, the database can have hundreds or thousands of isolated card corners ranging in quality from “poor” to “mint,” with every other grade type in between. By having so many isolated card corners of varying qualities in the system database, a good match can be obtained when comparing an isolated corner of the current card being graded to all of the isolated card corners contained in the database.

A given isolated feature of the current card being graded can be compared against all of the many similar card feature types already contained in the system to find the best comparisons for that given isolated feature. A grade or score can then be given for that given isolated feature based upon the comparisons with features in the database having known grades and scores, and this process can be repeated for every isolated spatial feature of the card being graded.

At the next process strep 510, a grade report can be created for the collectible card being graded. This grade report can be based on the results of applying the card feature model to the isolated spatial features of the card. Many or all of the feature to feature comparisons can be considered, and this can be done by way of averaging or otherwise considering the scoring of many different spatial feature comparisons. In some arrangement, a weighted formula or averaging can be used to arrive at an overall grade for the collectible card. Various category scores or sub-gradings can also be used to quantify the grade or quality of the graded card. The overall grade of the collectible card can then be provided to the user. In some embodiments, this can include a detailed report at how this overall grade was calculated. Various details of the grade report can include, for example, reasons for the overall grade including highlights of the biggest flaws of the card, such as torn corners, worn edges, surface scratches, off-centering of the card subject, and the like. The method then ends at end step 512.

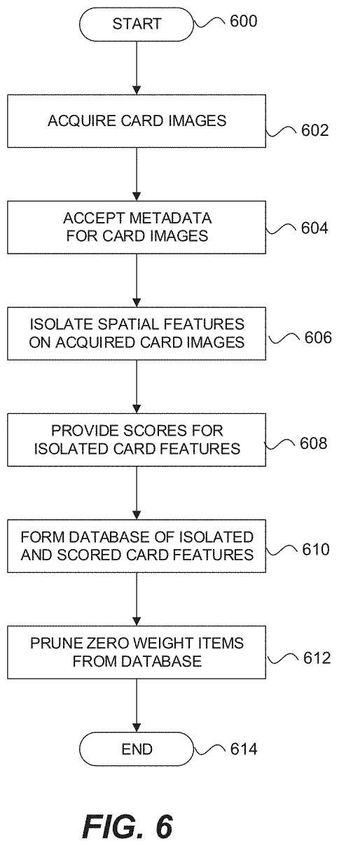

Continuing with FIG. 6, a flowchart of an exemplary method of generating a card feature model using a deep learning algorithm is provided. After a start step 600, collectible card images can be acquired at a process step 602. This can involve the acquisition of many hundreds or thousands of card images through a variety of means. Image acquisition devices used to capture such images can include scanners, cameras, software such as screen capture programs, and the like. Again, it is specifically contemplated that the high-resolution digital cameras on the latest release smart phones are suitable for the purpose of capturing images of collectible cards. Acquisition of card images can be accomplished manually by operators or custodians of the system, or other contributors to the system. In addition, users or consumers of the system can provide images of cards to be graded, which images can then be used to expand the database of card images in the system.

At a following process step 604, metadata for card images can be accepted into the system. This metadata can be automatically determined and generated, and/or may be manually entered by operators of the system, users, or both. Such metadata can include information relating to the various collectible card images in the system, such as those acquired at step 602 above. Metadata accepted into the system can include data relating to the subject of a collectible card, such as, for example, the year of issue, series, sport, game, title, or manufacturer of the collectible card, among other possible items, and such metadata can be organized on the database in a fashion that associates it with specific collectible cards, as appropriate. Other metadata may also be included, such as specialized notes or items, as may be applicable for particular collectible cards.

At a subsequent process step 606, various spatial features on these acquired card images can be isolated. Isolation of spatial features can be the same or similar as for the isolation of spatial features on cards that are being graded. This can involve the pre-processing of card images, as well as specialized processing applying the deep learning of the system CNN. Further details regarding isolating spatial features on collectible cards is provided below.

At the next process step 608, scores can be provided for the isolated card features. That is, each isolated card feature, such as a corner, an edge region, a central region, a surface impression, a card centering, and the like, can be assigned a score based on its quality. Such a score might range from 1 (e.g., poor) to 10 (e.g., mint), and can reflect the exact quality of that particular isolated card features. Scoring for isolated card features may be manual, automated, or through some mixture of manual and automated. For example, operators of the system may manually enter scores for several dozen or several hundred card features, providing at least one score at every iteration from lowest (e.g., 1) to highest (e.g., 10). The CNN can then use these manually entered scores as a base to augment the system by providing scores to newly added card features of the same type (e.g., corners) in an automated fashion.

At a following process step 610, a system database of isolated and scored card features can be formed. This can involve simply taking all of the isolated card features and scores provided at step 608 and storing images of the isolated card features and associated scores on a comprehensive database. In various embodiments, metadata associated with the various images of the isolated card features may also be stored on the database and associated with their respected images and scores. This database of isolated and scored card features with associated metadata can then be used by the CNN as a card feature model in order to grade future card submitted to the system.

At process step 612, zero or low weight items can be pruned from the database. This can serve to compress and streamline the CNN, the benefits of which will be readily appreciated. In general, many CNNs will have a proliferation of data and categories, such that processing or the transmission of data involving the CNN can be lengthy and cumbersome. By pruning zero weight and possibly low weight items from the database, this can facilitate a faster system that is just as reliable but less prone to delays and system crashes. The method then ends at end step 614.

It will be appreciated that the deep learning training of the CNN as part of generating a card feature model can involve several processes. During the training process of the CNN, several steps of “data augmentation” may be applied to artificially increase the size of the training dataset/database, including but not limited to clipped zooms, flips, brightness or color tuning, and translations of the database images. Furthermore, the CNN can be made to predict multiple values besides just a grade for a card. For example, the CNN can predict a price or value for a card, given the condition of the card from isolated spatial features and the metadata relating to the card.

It will also be appreciated that some amount of general image pre-processing may take place prior to the grading process on an individual card. While an image of the card may be procured and ready for analysis and grading, there can be some variances in size, light, color, and clarity across different images that are captured and submitted to the system. Accordingly, various generally well-known image pre-processing routines may be performed in order to standardize images. These can include image resizing to normalize the image size for all analyzed cards, as well as histogram equalization, which can normalize brightness and color conditions across images taken in varying conditions. Other image pre-processing techniques may also be used to standardize images captured under varying conditions, and all such image pre-processing techniques are contemplated for use with the disclosed systems and methods.

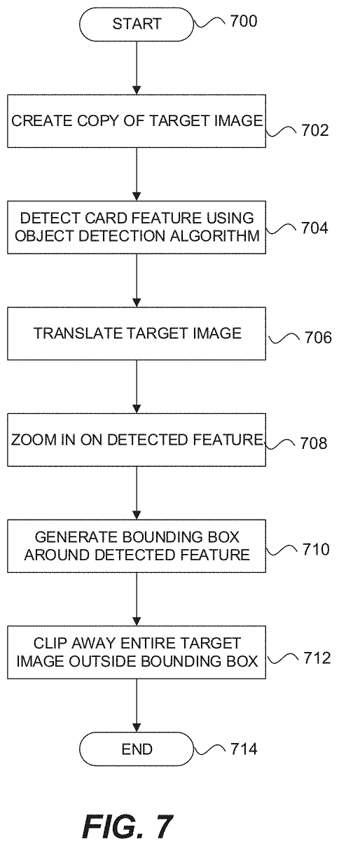

FIG. 7 illustrates a flowchart of an exemplary method of isolating a card spatial feature according to one embodiment of the present disclosure. After a start step 700, a copy of a target image can be created at a process step 702. In practice, many copies of the target image will be made during the processing and grading of the image. This is due to the fact that numerous spatial features of the card will be isolated and analyzed, such that copies of the target image can be made before reducing each copy to a specific isolated spatial feature. In the event that image pre-processing is performed on the initially acquired target image, then it may be preferable to perform any image pre-processing prior to making copies of the target image to isolate spatial features therefrom.

At a subsequent process step 704, a card feature can be detected on the target image (or copy of the target image) using an object detection system. Again, this can specifically be by way a YOLOv3 algorithm, although other object detection systems or algorithms may also be used. As noted above, card features subject to detection can include, corners, edge regions, central regions, surface representations, and the like. At process step 706, the target image (or copy thereof) can be translated, such as up, down, right, or left, after which the system can zoom in on the detected card feature at process step 708.

At a following process step 710, a bounding box can be drawn or otherwise generated around the detected card feature, after which the entire image outside the bounding box can be clipped away at process step 712. Preferably, the bounding box generated around the detected card feature can be as small as possible while still including the entire card feature that has been detected. The remaining image of an isolated spatial feature can then be used for grading purposes by comparing to other similar images of the same type of isolated spatial feature in the system. It will be appreciated that this method of isolating a card spatial feature can be repeated numerous times for the same collectible card, until all spatial features of interest on the card have been similarly isolated. For example, the system may require that spatial features isolated for a single card to be graded should or must include four corners, enough edge regions to comprise the entire edge of the card, and enough central regions to comprise all parts of interest for a collectible card of that subject or title. The method then ends at end step 714.

It will be appreciated that among the various factors considered for grading collectible cards, there is at least one that is significantly quantitative in nature rather than subjective. While grading the conditions of card corners, edges, central regions, and surface impressions can be a highly subjective process, for which the CNN disclosed herein eliminates such subjectivity, the grading of card centering is fairly quantitative and straightforward. Whether the centering of a card is a perfect 50/50, or 75/25 or worse, such an assessment is objective and can be measured by most any type of system. The CNN of the present disclosure can account for the centering of a card with such a straightforward process to arrive at a centering metric for a given card, and can then include the score assigned for the card centering as part of the overall card grading process.

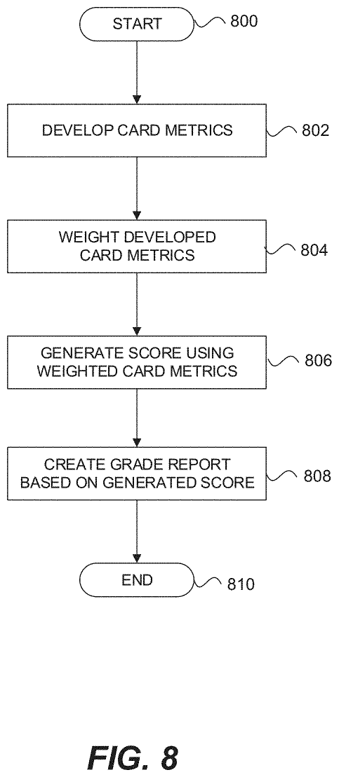

Lastly, FIG. 8 provides a flowchart of an exemplary method of creating a grade for a collectible card. After a start step 800, card metrics can be developed at a process step 802. These card metrics are developed by the CNN during comparisons between the isolated spatial features of the card being graded against isolated spatial features of cards already in the system. As noted above with respect to the generation of a card feature model, the system can include a database having many hundreds or thousands of images of isolated spatial features of cards. Each of these isolated spatial feature images can have a score associated therewith. Metrics for a card being graded are developed then when isolated spatial features of the card being graded are compared against those stored on the system and then given individual feature scores based on the closest comparisons.

At a following process step 804, the developed card metrics can be weighted based upon the importance of each individual card metric in computing an overall card score or grade. For example, a small scratch along one edge region of a card may not carry much weight when the overall condition of the card is poor or fair, but that same scratch may carry a significant weight when the rest of the card is in mint condition. Card metric weighting may be applied according to set weights or formulae that are set into the system, or such weighting may be dynamic based upon the general overall condition or category of a given card being graded.

At the next step 806, an overall card score can be generated using the weighted card metrics. Similar to the foregoing, the overall card score can be provided based on a set formula or process for calculating card score based on the weighted card metrics. For example, an overall card score might just be a simple average of three or four major card metrics. This might be, for example, the average of a corner score, an edge score, a central region score, and a surface impression score. In other arrangements, additional factors may be included, and some factors may have more weight than others. For example, some grading systems may place more emphasis on corners than the other card features, in which case an averaging of the various metrics can involve a multiplier factor for the corner score of a card.

A grade report based on the generated score can be created at step 808. This grade report can include an overall grade for the card, such as a number grade from 1 (e.g., poor) to 10 (e.g., mint). In some embodiments, the overall grade for the card may be the only portion of the grade report that is provided to a consumer or user. In other embodiments, further details may be provided in the grade report. These can include details regarding subscores or category scores for various parts of the overall grade, as well as explanations as to the biggest flaws or defects of the graded card. The method then ends at end step 810.

For the foregoing flowcharts, it will be readily appreciated that not every method step provided is always necessary, that the order of steps may be altered, and that further steps not set forth herein may also be included. For example, steps to involve taking and processing additional pictures may be added. Furthermore, the exact order of steps may be altered as desired, and some steps may be performed simultaneously. For example, step 506 may be performed before step 502 in some instances. In addition, while the provided examples are with respect to collectible cards specifically, it will be readily understood that such methods can also be adapted to include other types of collectibles.

It will be readily appreciated that the foregoing examples are merely representative, and that the various systems and methods disclosed herein can be extrapolated for additional uses and features. For example, while the foregoing examples describe systems where only one image is captured for the front of a collectible card, it will be readily appreciated that multiple images may be captured and used in the disclosed grading system. In various embodiments, a second picture of the obverse side of the card may be captured and input into the system for grading. For such instances where a second obverse image is used, the system may assign more weight to the scores assigned to the front side of the card than to the obverse side of the card. For example, the overall score may be weighted to 90% for the front side of the card and 10% for the obverse side of the card.

Various applications of the disclosed systems and methods are also contemplated. For example, the disclosed systems and methods may be applied as a service performed on a remote server over the cloud, or may be performed entirely locally, such as by a comprehensive app on the smart phone of a user. In further applications, the disclosed systems and methods may be used in conjunction with the commercialization of a collectible card. For example, a user listing his or her card to an online or other virtual marketplace, such as an online auction or sales website, may submit a picture of the card as part of the listing or sale process. The online or virtual marketplace may then use the disclosed systems and methods to perform grading on the listed card as part of the listing process. The assigned grade may then be provided as part of the listing on the website or other virtual marketplace. Other applications of the disclosed systems and methods may also be applicable.

The various aspects, embodiments, implementations or features of the described embodiments can be used separately or in any combination. Various aspects of the described embodiments can be implemented by software, hardware or a combination of hardware and software. Computer readable medium can be any data storage device that can store data which can thereafter be read by a computer system. Examples of computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A method of grading a collectible card, the method comprising:
receiving from an image acquisition device a target image of a first collectible card depicting a first subject, wherein the first subject is a specific collectible card representation created by a collectible card manufacturer;
isolating spatial features of the target image, the spatial features including one or more of a corner, an edge region, a central region, and a surface impression of the first collectible card;
generating a card feature model using a deep learning algorithm trained using other images of other collectible cards, wherein the other images are isolated into spatial features including corners, edge regions, central regions, and surface impressions;
applying the card feature model to one or more of the isolated spatial features of the target image to create a plurality of card metrics; and
creating a grade report for the first collectible card based at least in part on one or more of the plurality of card metrics.

2. The method of claim 1, wherein the isolating the corner of the first collectible card includes detecting a card corner in the target image, and generating a bounding box around the card corner.

3. The method of claim 1, wherein the isolating the edge region of the first collectible card includes detecting a card edge in the target image, and generating a bounding box around a portion of the card edge that is less than the entire card edge.

4. The method of claim 1, wherein the isolating the central region of the first collectible card includes detecting a central portion of the card that excludes all corners and all edge regions in the target image, and generating a bounding box around the central region.

5. The method of claim 1, wherein the isolating the surface impression of the first collectible card includes detecting one or more scratches, bumps, folds, or other surface imperfections of the card in the target image, and generating a bounding box around the one or more scratches, bumps, folds, or other surface imperfections.

6. The method of claim 1, wherein the isolating the spatial features includes zooming in on a spatial feature, generating a bounding box around the spatial feature, and clipping away the rest of the target image outside the spatial feature.

7. The method of claim 1, wherein the isolating the spatial features includes translating the target image by moving the target image up, down, left, or right.

8. The method of claim 1, wherein the isolating the spatial features includes isolating every corner, every edge region, and every central region of the first collectible card.

9. The method of claim 1, wherein the generating the card feature model includes inputting card metadata into the deep learning algorithm by entering data relating to the first subject of the first collectible card, the data including information regarding the year of issue, series, sport, game, title, or manufacturer of the first collectible card.

10. The method of claim 1, wherein the deep learning algorithm includes a convolutional neural network and generating the card feature model includes compressing the convolutional neural network by pruning items having zero parameters and weights within the convolutional neural network.

11. The method of claim 1, wherein the creating the grade report includes generating a score incorporating weighting or factor reduction for one or more of the plurality of card metrics.

12. The method of claim 1, wherein the applying the card feature model includes comparing isolated spatial features of the first collectible card with isolated spatial features of the other collectible cards.

13. The method of claim 1, wherein the other collectible cards used to train the deep learning algorithm depict subjects that are different than the first subject.

14. The method of claim 1, wherein the image acquisition device is a smart phone.

15. The method of claim 1, wherein the first collectible card is a sports or trading game card.

16. A system adapted for the automated grading of collectible cards, the system comprising:
at least one memory that contains non-transitory processor-executable instructions;
a communication interface configured to facilitate communications between the system and separate computing devices outside the system; and
a processor coupled to the at least one memory and to the communication interface, the processor being configured to execute the processor-executable instructions, wherein the processor-executable instructions include:
receiving from an image acquisition device a target image of a first collectible card depicting a first subject, wherein the first subject is a specific collectible card representation created by a collectible card manufacturer,
isolating spatial features of the target image, the spatial features including one or more of a corner, an edge region, a central region, and a surface impression of the first collectible card,
generating a card feature model using a deep learning algorithm trained using other images of other collectible cards, wherein the other images are isolated into spatial features including corners, edge regions, central regions, and surface impressions,
applying the card feature model to one or more of the isolated spatial features of the target image to create a plurality of card metrics, and
creating a grade report for the first collectible card based at least in part on one or more of the plurality of card metrics.

17. The system of claim 16, wherein isolating spatial features includes isolating every corner, every edge region, and every central region of the first collectible card.

18. The system of claim 16, wherein applying the card feature model includes comparing isolated spatial features of the first collectible card with isolated spatial features of the other collectible cards.

19. An apparatus, comprising:
a processor configured to execute processor-executable instructions that include:
receiving a target image of a collectible depicting a subject, wherein the subject is a specific representation created by a collectible manufacturer,
isolating spatial features of the target image, the spatial features including one or more of an edge region, a central region, and a surface impression of the collectible,
generating a feature model using a deep learning algorithm trained using other images of other collectibles, wherein the other images are isolated into spatial features including edge regions, central regions, and surface impressions,
applying the feature model to one or more of the isolated spatial features of the target image to create a plurality of collectible metrics, and
creating a grade report for the collectible based at least in part on one or more of the plurality of collectible metrics.

20. The apparatus of claim 19, wherein the generating the feature model includes inputting collectible metadata into the deep learning algorithm by entering data relating to the subject of the collectible, the data including information regarding the year of issue, series, title, or manufacturer of the collectible.
